(19) United States
(12) Patent Application Publication
(10) Pub. No.: US 2010/0330453 A1
(43) Pub. Date: Dec. 30, 2010

(54) POLYMER ELECTROLYTE MEMBRANE FOR FUEL CELL SYSTEM AND MANUFACTURING METHOD THEREOF

(75) Inventors: Sang-Il Han, Yongin-si (KR); Tae-Yoon Kim, Yongin-si (KR); Hee-Tak Kim, Yongin-si (KR); Kah-Young Song, Yongin-si (KR); Myoung-Ki Min, Yongin-si (KR); Sung-Yong Cho, Yongin-si (KR); Geun-Seok Chai, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Yongin-si (KR)

(21) Appl. No.: 12/819,405

(22) Filed: Jun. 21, 2010

(30) Foreign Application Priority Data
Jun. 25, 2009 (KR) 10-2009-0057232

(51) Int. Cl. H01M 8/10; H01M 8/00

(52) U.S. Cl. 429/483; 429/492; 429/535

(57) ABSTRACT

A polymer electrolyte membrane for a fuel cell has a crystalline fusion enthalpy measured by differential scanning calorimetry (DSC) of about 67.3 J/g or more. Such crystallinity improves dimensional stability, mechanical characteristics, and ion conductivity of the polymer electrolyte membrane.

### CROSS-REFERENCE TO RELATED APPLICATION

This application claims the benefit of Korean Application No. 10-2009-0057232, Jun. 25, 2009, filed in the Korean Intellectual Property Office, the disclosure of which is incorporated herein by reference.

### BACKGROUND OF THE INVENTION

1. Field of the Invention

Exemplary embodiments relate generally to a polymer electrolyte membrane for a fuel cell, and a method of manufacturing the same.

2. Description of the Related Art

A fuel cell is a power generation system for producing electrical energy through an electrochemical reduction-oxidation reaction of an oxidant and hydrogen from a hydrocarbon-based material such as methanol, ethanol, and natural gas.

Such a fuel cell is a clean energy source that may replace fossil fuels. It includes a stack composed of unit cells that produce various ranges of power. Since it has a four to ten times higher energy density than a small lithium battery, it has been high-lighted as a small portable power source.

Typical examples of fuel cells are polymer electrolyte membrane fuel cells (PEMFC) and direct oxidation fuel cells (DOFC). A direct oxidation fuel cell that uses methanol as a fuel is called a direct methanol fuel cell (DMFC).

The polymer electrolyte fuel cell has high energy density and power. However, polymer electrolyte fuel cells require careful handling of hydrogen gas and require accessory facilities, such as a fuel reforming processor to reform a fuel gas, such as methane, methanol, and natural gas, in order to produce hydrogen.

On the contrary, the direct oxidation fuel cell has a lower energy density than the polymer electrolyte fuel cell, but the direct oxidation fuel cells have the advantages of easy handling of a liquid-type fuel, a low operation temperature, and no requirement for additional fuel reforming processors.

In the above-described fuel cells, the stack that actually generates electricity includes several to scores of unit cells stacked in multi-layers, and each unit cell is made up of a membrane-electrode assembly (MEA) and a separator (also referred to as a bipolar plate). The membrane-electrode assembly has an anode (referred to as a fuel electrode or an oxidation electrode) and a cathode (referred to as an air electrode or a reduction electrode) attached to each other with an electrolyte membrane disposed therebetween.

A fuel is supplied to an anode, adsorbed on catalysts of the anode, and is then oxidized to produce protons and electrons. The electrons are transferred to the cathode via an external circuit, and the protons are transferred to the cathode through the polymer electrolyte membrane. In addition, an oxidant is supplied to the cathode. Then, the oxidant, protons, and electrons react on catalysts of the cathode, thereby producing electricity and water.

### SUMMARY OF THE INVENTION

Aspects of the present invention provide a polymer electrolyte membrane for a fuel cell having excellent dimensional stability, mechanical characteristics, and ion conductivity. Another aspect provides a membrane-electrode assembly that includes the polymer electrolyte membrane for a fuel cell. Yet another aspect provides a fuel cell having excellent electric power density that includes the membrane-electrode assembly. Still another aspect provides a method of preparing the polymer electrolyte membrane for a fuel cell.

According to an aspect, a polymer electrolyte membrane for a fuel cell is provided that has a crystallinity such that a crystalline fusion enthalpy of the polymer electrolyte membrane measured by differential scanning calorimetry (DSC) is about 67.3 J/g or more.

Aspects of the present invention provide a polymer electrolyte membrane for a fuel cell has an exothermic peak in the range of about 125 to about 200° C. as measured by differential scanning calorimetry (DSC). According to aspects of the present invention, the polymer electrolyte membrane for a fuel cell may have an X-ray diffraction (XRD) peak at a 20 to 23 degree diffraction angle (2θ) at a wide-angle X-ray diffraction spectrum analysis using a CuKα ray. According to aspects of the present invention, the polymer electrolyte membrane also may have a peak intensity ratio (H/N) ranging from about 0.3 to about 0.9 wherein the intensity ratio (H/N) refers to a ratio of an XRD peak intensity (H) at a 20 to 23 degree diffraction angle (2θ) with respect to an XRD peak intensity (N) at a 16 to 18 degree diffraction angle (2θ). According to aspects of the present invention, the polymer electrolyte membrane for a fuel cell may be formed from a mixture of a proton conductive polymer powder and a polyhydric alcohol. According to aspects of the present invention, the proton conductive polymer powder may include a cation exchange group selected from the group consisting of a sulfonic acid group, a carboxylic acid group, a phosphoric acid group, a phosphonic acid group, and derivatives thereof, at its side chain. According to aspects of the present invention, the polyhydric alcohol has a solubility parameter (δ) ranging from about 8 to about 24 (cal/cm³)^{1/2}.

According to another aspect, a method of preparing a polymer electrolyte membrane includes preparing a cluster by mixing a proton conductive polymer powder and a polyhydric alcohol, drying the cluster, and heat-treating the dried cluster.

According to aspects of the present invention, the cluster includes a polyhydric alcohol at about 10 to about 1000 parts by volume based on 100 parts by volume of the proton conductive polymer powder. According to aspects of the present invention, the proton conductive polymer powder includes a cation exchange group selected from the group consisting of a sulfonic acid group, a carboxylic acid group, a phosphoric acid group, a phosphonic acid group, and derivatives thereof, at its side chain. According to aspects of the present invention, the polyhydric alcohol has a solubility parameter (δ) ranging from 8 to 24 (cal/cm³)^{1/2}. According to aspects of the present invention, the drying is performed at a temperature of about 60 to about 80° C., and the heating is performed at a temperature of about 100 to about 140° C.

According to yet another aspect, a membrane-electrode assembly for a fuel cell is provided that includes a cathode and an anode facing each other, and a polymer electrolyte membrane disposed therebetween. According to aspects of the present invention, the polymer electrolyte membrane includes the above polymer electrolyte membrane for a fuel cell according to aspects of the present invention.

According to still another aspect, a fuel cell system is provided that includes at least one electrical generator, a fuel supplier, and an oxidant supplier. According to aspects of the present invention, the electrical generator includes an anode and a cathode facing each other, with a polymer electrolyte membrane disposed therebetween. According to aspects of the present invention, the polymer electrolyte membrane includes the polymer electrolyte membrane for a fuel cell according aspects of the present invention.

According to aspects of the present invention, the polymer electrolyte membrane for a fuel cell has excellent dimensional stability and mechanical characteristics, and reduced material transfer resistance. Also, according to aspects of the present invention, the polymer electrolyte membrane may be disposed in a membrane-electrode assembly and provide a fuel cell having excellent electrical power density due to its improved ion conductivity.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically shows a structure of a fuel cell system according to one embodiment.

FIG. 2 is a transmission electron microscope (TEM) photograph of the polymer electrolyte membrane for a fuel cell according to Example 1.

FIG. 3 is transmission electron microscope (TEM) photographs of the polymer electrolyte membrane for a fuel cell according to Example 4.

FIG. 4 is a polarization microscope photograph of commercially available NAFION® 211 (DuPont Co., Ltd.) according to Comparative Example 1.

FIG. 5 is a graph showing measurement results of a differential scanning calorimetry (DSC) of polymer electrolyte membranes for a fuel cell according to Examples 1 to 5 and Comparative Example 1.

FIG. 6 is a graph showing wide-angle X-ray diffraction spectra of the polymer electrolyte membranes for a fuel cell according to Examples 1 to 3 and Comparative Examples 1 and 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. This disclosure may, however, be embodied in many different forms and is not to be construed as limited to the exemplary embodiments set forth herein. Further, when a range of values is described, the range includes ranges having any endpoints within the described range.

The polymer electrolyte membrane for a fuel cell according to one embodiment has crystallinity such that crystalline fusion enthalpy measured by differential scanning calorimetry (DSC) is about 67.3 J/g or more. In another embodiment, the crystalline fusion enthalpy may range from about 67.3 to about 130 J/g.

Conventional polymer electrolyte membranes have no crystallinity in terms of differential scanning calorimetry measurement. In this case, the polymer electrolyte membranes for a fuel cell have the problems of being easily expanded by water and having reduced dimensional stability. On the contrary, the polymer electrolyte membrane for a fuel cell according to one embodiment has crystalline fusion enthalpy of about 67.3 J/g or more in the DSC measurement, and thereby has improved polymer chain mobility. From such measurements, it is confirmed that crystallization is caused by the polymer included in a polymer electrolyte membrane. Accordingly, the polymer electrolyte membrane for a fuel cell may have improved dimensional stability and mechanical strength. The polymer electrolyte membrane for a fuel cell may have an exothermic peak at 125 to 200° C. in the DSC measurement.

The DSC measurement is performed while increasing the temperature from about 25° C. to about 300° C. at a speed of about 5 to about 20° C./min under the condition of drying the polymer electrolyte membrane.

The polymer electrolyte membrane according to one embodiment has additionally derived crystallization and provides an X-ray diffraction (XRD) peak at a diffraction angle (2θ) of about 20 to about 23 degrees in a wide-angle X-ray diffraction spectrum analysis using a CuKα ray.

The polymer electrolyte membrane of the fuel cell has a peak intensity ratio (H/N) ranging from about 0.3 to about 0.9, or any range having end points therebetween. The intensity ratio (H/N) refers to a ratio of an XRD peak intensity (H) at a diffraction angle (2θ) of about 20 to about 23 degrees with respect to an XRD peak intensity (N) at a diffraction angle (2θ) of about 16 to about 18 degrees. The XRD peak at a diffraction angle (2θ) of about 16 to about 18 degrees is a main peak that is generally caused by a proton conductive polymer. The polymer electrolyte membrane according to one embodiment has a peak intensity ratio (H/N) ranging from about 0.3 to about 0.9 where the peak intensity ratio (H/N) refers to a ratio of an XRD peak intensity (H) at a diffraction angle (2θ) of about 20 to about 23 degrees with respect to the main peak intensity (N), indicating that the polymer electrolyte membrane has been additionally crystallized.

The wide-angle X-ray diffraction spectrum was measured by using a CuKα ray as a light source while increasing the diffraction angle (2θ) at a speed of about 1 to about 10 degrees/min.

A polymer electrolyte membrane according to one embodiment is obtained from a mixture of a proton conductive polymer powder and a polyhydric alcohol.

The proton conductive polymer powder may be used as any one obtained from a proton conductive polymer resin that is generally used in a polymer electrolyte membrane. The proton conductive polymer powder may include a cation exchange group. The cation exchange group may be selected from the group consisting of a sulfonic acid group, a carboxylic acid group, a phosphoric acid group, a phosphonic acid group, and derivatives thereof, at its side chain.

The polyhydric alcohol may have a solubility parameter (δ) ranging from about 8 to about 24 (cal/cm³)^{1/2}, or any range having end points therebetween. For example, in one embodiment, the polyhydric alcohol may have a solubility parameter (δ) ranging from 9.5 to 13 (cal/cm³)^{1/2}. The polyhydric alcohol causes additional crystallization by improving mobility of a polymer chain. It may be selected from the group consisting of a glycerol, an alkyleneglycol, an alkyleneglycol alkylether, and combinations thereof. The alkyleneglycol may, for example, be one or combinations of dipropylene glycol (DPG) and propylene glycol. The alkyleneglycol alkylether may, for example, be one or combinations of propylene glycol methyl ether, ethylene glycol dimethyl ether, and ethylene glycol monobutyl ether. The term “alkylene” may refer to a C1 to C10 alkylene, and the term “alkyl” may refer to a C1 to C10 alkyl. The polyhydric alcohol may also be used along with a generally-used water-soluble solvent, such as an isopropyl alcohol, water, and the like.

The proton conductive polymer powder may be selected from the group consisting of a fluorine group polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyether-etherketone-based polymer, a polyphenylquinoxaline-based polymer and combinations thereof. In another embodiment, the proton conductive polymer powder may be selected from the group consisting of a polyperfluorosulfonic acid (commercially available as NAFION®), a polyperfluorocarboxylic acid, a sulfonic acid-containing copolymer of a tetrafluoroethylene and a fluorovinylether, defluorinated polyetherketone sulfide, aryl ketone, a poly(2,2′-(m-phenylene)-5,5′-bibenzimidazole, poly (2,5-benzimidazole), and/or combinations thereof.

The hydrogen (H) of a proton conductivity group of the proton conductive polymer powder may be substituted with Na, K, Li, Cs, or tetrabutylammonium. NaOH may be used when H is substituted with Na from a proton conductivity group of a proton conductive polymer powder, tetrabutylammonium hydroxide is substituted with a tetrabutylammonium, and K, Li, or Cs may be substituted with a suitable compound. The proton conductive polymer substituted with the Na, K, Li, Cs, or tetrabutylammonium is re-sulfonized when a catalyst layer is later treated with a sulfonic acid and thereby changes into a proton-type polymer.

One embodiment provides a manufacturing method for preparing a polymer electrolyte membrane for a fuel cell that includes preparing a cluster by mixing a polymer powder that has proton conductivity and a polyhydric alcohol, drying the cluster, and heating the dried cluster.

The cluster may include about 10 to about 1000 parts by volume of polyhydric alcohol based on 100 parts by volume of the proton conductive polymer powder. In one embodiment, the cluster may include about 100 to about 1000 parts by volume of polyhydric alcohol based on 100 parts by volume of the proton conductive polymer powder.

One embodiment provides a polyhydric alcohol that initiates crystallization of the proton conductive polymer powder for the polymer electrolyte membrane for a fuel cell, and it may improve mobility of the polymer chains therein. Therefore, it may improve flexibility and mechanical strength of a polymer electrolyte membrane for a fuel cell. When a proton conductive polymer powder and a polyhydric alcohol are included at such volume ratios, it may decrease cross-over of a fuel by preventing excessive agglomeration between ionomer clusters and maintaining the average particle diameter of an ionomer cluster agglomeration in a range of about 5 to about 300 nm.

The proton conductive polymer powder may include a cation exchange group selected from the group consisting of a sulfonic acid group, a carboxylic acid group, a phosphoric acid group, a phosphonic acid group, and derivatives thereof, at its side chain. The polyhydric alcohol may have a solubility parameter (δ) in the range of 8 to 24 (cal/cm³)^{1/2}.

The cluster may further include a solvent. The solvent may be added at the same time when mixing the proton conductive polymer powder and polyhydric alcohol, or may be added after sufficiently mixing the proton conductive polymer powder and polyhydric alcohol. The solvent may be included in an amount of about 10 to about 900 parts by volume based on 100 parts by volume of the proton conductive polymer powder. The polyhydric alcohol and the solvent may be included at a volume ratio of about 50 to 90:about 10 to 50, or in one embodiment, about 70 to 90:about 10 to 30.

The solvent may include water, isopropyl alcohol (IPA), or combinations thereof, but is not limited thereto. The term “water” refers to water from which impurities are removed, for example distilled water, deionized water, and the like.

The kind of components and properties of the polymer electrolyte membrane for a fuel cell may be the same as illustrated above.

The drying process may be performed at a temperature of about 60 to about 80° C. in an oven, considering browning of a polymer electrolyte membrane and removing of a polyhydric alcohol. The drying process may be performed under vacuum or in an inert gas atmosphere. A group 18 gas, such as argon gas, or nitrogen gas may be generally used as the inert gas.

The heat treatment may be performed in the range of about 100 to about 140° C. to maximize isothermal crystallinity of a polymer electrolyte membrane. The heat treatment may be performed under a vacuum atmosphere.

The polymer electrolyte membrane of a fuel cell according to embodiments may have improved dimensional stability, have excellent mechanical characteristics, and decrease mass transfer resistance for a fuel cell due to crystallization derived by simple heat treatment. It may also improve ion conductivity, and therefore, a membrane-electrode assembly and a fuel cell having excellent electrical power density may be provided.

The polymer electrolyte membrane for a fuel cell electrically insulates an anode and a cathode, transfers protons from the anode to the cathode during the cell operation reaction, and also separates gas and liquid reactants.

A polymer electrolyte membrane is required to have excellent electrochemical stability, low ohmic loss at a high current density, good separation properties between gas and liquid reactants during cell operation, and predetermined mechanical properties and dimensional stability for stack fabrication.

According to one embodiment, a membrane-electrode assembly is provided, which includes an anode and a cathode facing each other, and a polymer electrolyte membrane prepared according to aspects of the present invention disposed therebetween. The cathode and the anode may each include an electrode substrate and a catalyst layer.

The catalyst layer can include any catalyst participating in a fuel cell reaction, for example, a platinum-based catalyst. The catalyst may be at least one selected from the following: platinum, ruthenium, osmium, a platinum-ruthenium alloy, a platinum-osmium alloy, a platinum-palladium alloy, or a platinum-M alloy (M is at least one transition element selected from the group consisting of Ga, Ti, V, Cr, Mn, Fe, Co, Ni, Cu, Zn, Sn, Mo, W, Rh, and Ru). As mentioned above, the anode and the cathode may include the same materials. However, a direct oxidation fuel cell may include a platinum-ruthenium alloy catalyst as an anode catalyst in order to prevent catalyst poisoning due to CO generated during the anode reaction. Non-limiting examples of the platinum-based catalyst may be one selected from the following: Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, or combinations thereof.

Such a metal catalyst may be used in a form of a metal itself (black catalyst), or one supported on a carrier. The carrier may include a carbon-based material, such as graphite, denka black, ketjen black, acetylene black, carbon nanotubes, carbon nanofiber, carbon nanowire, carbon nanoballs, activated carbon, and so on, or an inorganic particulate such as alumina, silica, zirconia, titania, and so on, but aspects are not limited thereto. A noble metal supported on a carrier may be a commercially available one or can be prepared by supporting a noble metal on a carrier.

The catalyst layer may further include a binder resin to improve its adherence and proton transfer properties. The binder resin may be proton conductive polymer resins having a cation exchange group selected from the group consisting of a sulfonic acid group, a carboxylic acid group, a phosphoric acid group, a phosphonic acid group, and derivatives thereof, at its side chain. Non-limiting examples of the proton conductive polymer include at least one of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. In one embodiment, the proton conductive polymer may be at least one of poly(perfluorosulfonic acid), poly(perfluorocarboxylic acid), a sulfonic acid group-containing copolymer of tetrafluoroethylene and fluorovinylether, polyetherketone sulfide, aryl ketone, poly(2,2′-(m-phenylene)-5,5′-bibenzimidazole), and poly (2,5-benzimidazole).

The hydrogen (H) in the cation exchange group of the proton conductive polymer may be substituted with Na, K, Li, Cs, or tetrabutylammonium. When the H in the cation exchange group of the terminal end of the proton conductive polymer side chain is substituted with Na or tetrabutylammonium, NaOH or tetrabutyl ammonium hydroxide may be used during preparation of the catalyst composition, respectively. When the H is substituted with K, Li, or Cs, suitable compounds for the substitutions may be used. The proton conductive polymer substituted with Na, K, Li, Cs, or tetrabutyl ammonium may be resulfonated and changed to a proton type by a sulfuric acid treating process on a catalyst layer.

The binder resin may be used singularly or as a mixture. Optionally, the binder resin may be used along with a non-conductive polymer to improve adherence between a polymer electrolyte membrane and the catalyst layer. The amount of the binder resin used may be adjusted to its usage purpose.

Non-limiting examples of the non-conductive polymer include at least one of polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), ethylenechlorotrifluoro-ethylene copolymers (ECTFE), polyvinylidene fluoride, polyvinylidene fluoride-hexafluoropropylene copolymers (PVDF-HFP), dodecyl benzenesulfonic acid, sorbitol, or combinations thereof.

The electrode substrates support the anode and cathode and provide a path for transferring fuel and oxidant to catalyst layers of the anode and cathode. In one embodiment, the electrode substrates are formed from a material such as carbon paper, carbon cloth, carbon felt, or a metal cloth (a porous film composed of metal fiber or a metal film disposed on a surface of a cloth composed of polymer fibers). However, the electrode substrate is not limited thereto.

The electrode substrates may be treated with a fluorine-based resin to be water-repellent to prevent deterioration of diffusion efficiency due to water generated during operation of a fuel cell. Non-limiting examples of the fluorine-based resin may include at least one of polytetrafluoroethylene, polyvinylidene fluoride, polyhexafluoropropylene, polyperfluoroan alkylvinylether, polyperfluorosulfonyl fluoride alkoxyvinyl ether, fluorinated ethylene propylene, polychlorotrifluoroethylene, or combinations thereof.

A microporous layer can be added between the aforementioned electrode substrates and catalyst layer to increase reactant diffusion effects. The microporous layer generally includes conductive powders with a particular particle diameter. The conductive material may include, but is not limited to, at least one of carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the electrode substrate. The binder resin may include, but is not limited to, at least one of polytetrafluoroethylene, polyvinylidenefluoride, polyhexafluoropropylene, polyperfluoroan alkylvinylether, polyperfluorosulfonylfluoride, alkoxyvinyl ether, polyvinylalcohol, cellulose acetate, and/or copolymers thereof. The solvent may include, but is not limited to, at least one of water; alcohols, such as ethanol, isopropyl alcohol, n-propyl alcohol, and butanol; dimethyl acetamide; dimethylsulfoxide; N-methylpyrrolidone; tetrahydrofuran; and so on. The coating method may include, but is not limited to, at least one of screen printing, spray coating, doctor blade methods, gravure coating, dip coating, silk screening, painting, and so on, depending on the viscosity of the composition.

According to an embodiment, a fuel cell system includes at least one of an electricity generating element, a fuel supplier, and an oxidant supplier. The electricity generating element includes an anode and a cathode facing each other, and a polymer electrolyte membrane disposed therebetween. The polymer electrolyte membrane includes a polymer electrolyte membrane for a fuel cell according to aspects of the present invention.

The electricity generating element generates electricity through oxidation of a fuel and reduction of an oxidant.

The fuel supplier supplies the electricity generating element with a fuel including hydrogen, and the oxidant supplier supplies the electricity generating element with an oxidant. The oxidant includes oxygen or air.

The fuel includes liquid or gaseous hydrogen, or a hydrocarbon-based fuel, such as methanol, ethanol, propanol, butanol, or natural gas, but is not limited thereto.

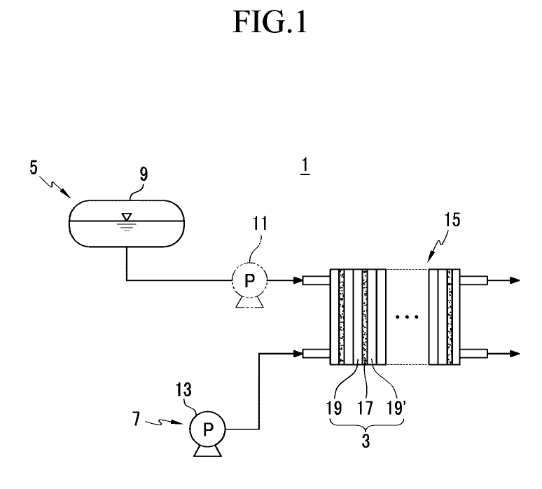

FIG. 1 shows a schematic structure of a fuel cell system of the embodiment, which will be described in detail as follows. FIG. 1 shows a fuel cell system that supplies a fuel and an oxidizing agent to an electrical generating element using a pump, but the fuel cell system according to the embodiment is not limited to such structures. The fuel cell system of the embodiment may alternatively include a structure wherein a fuel and an oxidant are provided via diffusion.

A fuel system 1 according aspects of the present invention includes at least one electricity generating element 3 that generates electrical energy by oxidation of a fuel and reduction of an oxidizing agent, a fuel supplier 5 to supply the fuel to the electricity generating element 3, and an oxidant supplier 7 for supplying an oxidant to the electricity generating element 3.

In addition, the fuel supplier 5 is equipped with a tank 9, which stores fuel, and a pump 11, which is connected therewith. The fuel pump 11 supplies fuel that is stored in the tank 9 with a predetermined pumping power.

The oxidant supplier 7, which supplies the electricity generating element 3 with the oxidant, is equipped with at least one oxidant pump 13 for supplying the oxidant with a predetermined pumping power.

The electricity generating element 3 includes a membrane-electrode assembly 17, which oxidizes hydrogen or a fuel and reduces an oxidant, and separators 19 and 19′ that are respectively positioned at opposite sides of the membrane-electrode assembly and that supply hydrogen or a fuel, and an oxidant, respectively to the membrane-electrode assembly 17. The stack 15 is formed by stacking at least one of the electricity generating elements 3.

The following examples illustrate the disclosure in more detail. However, it is understood that the disclosure is not limited by these examples. A person having ordinary skills in this art can sufficiently understand parts of the disclosure that are not described.

<Manufacturing Polymer Electrolyte Membrane for a Fuel Cell>

### Example 1

A solution including 5 wt % NAFION® (polyperfluorosulfonic acid, DuPont Co., Ltd.) and distilled water and 2-propanol solvent was spray-dried to provide a proton conductive polymer powder having an average particle diameter of 500 nm. 700 parts by volume of dipropylene glycol (DPG) and 300 parts by volume of distilled water (DW) were added to 100 parts by volume of the proton conductive polymer powder to prepare a cluster.

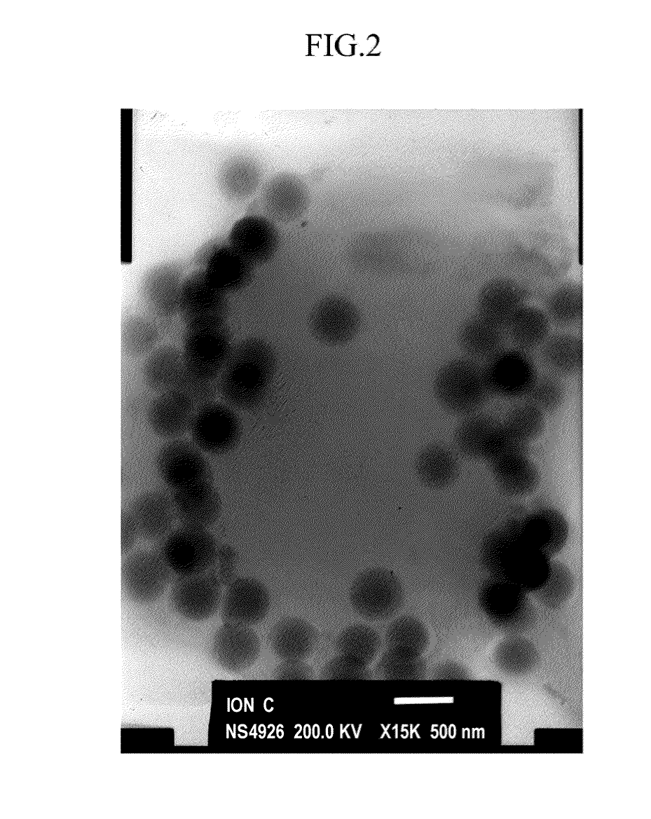

The cluster was cast on a glass plate and dried in an 80° C. vacuum oven for 48 hours. After the drying process, the final polymer electrolyte membrane was prepared by heat treatment at 120° C. for 24 hours. Then, it was examined by using transmission electron microscopy (TEM). The result is shown in FIG. 2.

As shown in FIG. 2, the polymer electrolyte membrane for a fuel cell including polyhydric alcohol according to Example 1 included an ionomer cluster agglomeration that had an average particle diameter about 280 nm. Thereby, it may be expected that the crystallinity was improved due to increased mobility of an ionomer main chain.

### Example 2

A polymer electrolyte membrane was manufactured according to the same method as in Example 1, except that 700 parts by volume of dipropylene glycol and 300 parts by volume of isopropyl alcohol (IPA) were added to 100 parts by volume of the proton conductive polymer powder to prepare a cluster.

### Example 3

A polymer electrolyte membrane was manufactured according to the same method as in Example 1, except that 300 parts by volume of dipropylene glycol and 700 parts by volume of isopropyl alcohol were added to 100 parts by volume of a proton conductive polymer powder to prepare a cluster.

### Example 4

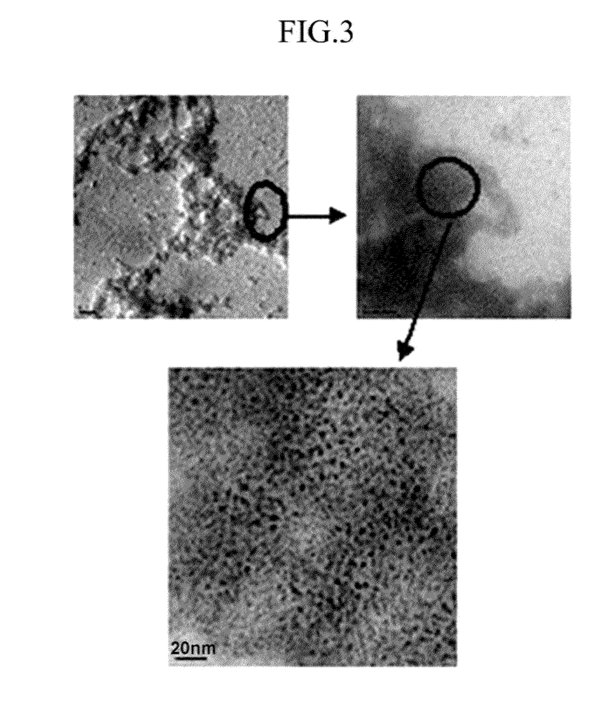

A polymer electrolyte membrane was manufactured according to the same method as in Example 1, except that 1000 parts by volume of dipropylene glycol were added to 100 parts by volume of a proton conductive polymer powder to prepare a cluster. Then, it was examined by using transmission electron microscopy (TEM). The result is shown in FIG. 3.

As shown in FIG. 3, the polymer electrolyte membrane for a fuel cell including polyhydric alcohol according to Example 4 included an ionomer cluster agglomeration that had an average particle diameter of about 5 nm. Thereby, it may be expected that the crystallinity was improved due to increased mobility of an ionomer main chain.

### Comparative Example 1

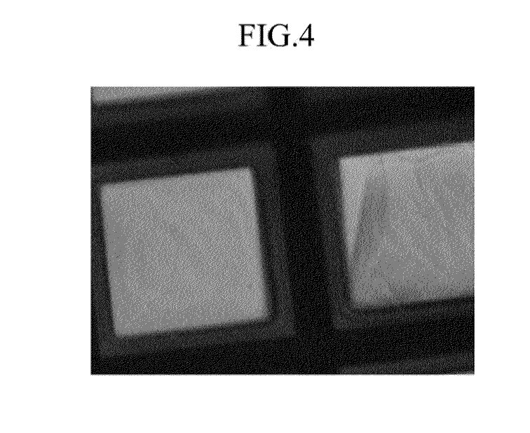

Commercially available NAFION® 211 (DuPont Co., Ltd.) was prepared to compare with the characteristics of the polymer electrolyte membrane for a fuel cell prepared according to aspects of the present invention. FIG. 4 is a polarization microscope photograph of a part of a commercial NAFION® 211 (DuPont Co. Ltd) cast on a TEM grid.

As shown in FIG. 4, in the polarization microscope photograph of a polymer electrolyte membrane according to Comparative Example 1 not including a polyhydric alcohol, an ionomer cluster agglomeration was not shown. Instead the polymer electrolyte membrane according to Comparative Example 1 is shown as a thin transparent membrane.

### Comparative Example 2

The NAFION® (DuPont Co. Ltd) solution including 5 wt % NAFION® and distilled water and 2-propanol solvent used in Example 1 without the additional DPG and DW was cast on a glass plate and dried in a 80° C. vacuum oven for 48 hours. After the drying process, the final polymer electrolyte membrane was prepared by heat treatment at 120° C. for 24 hours.

### Experimental Example 1

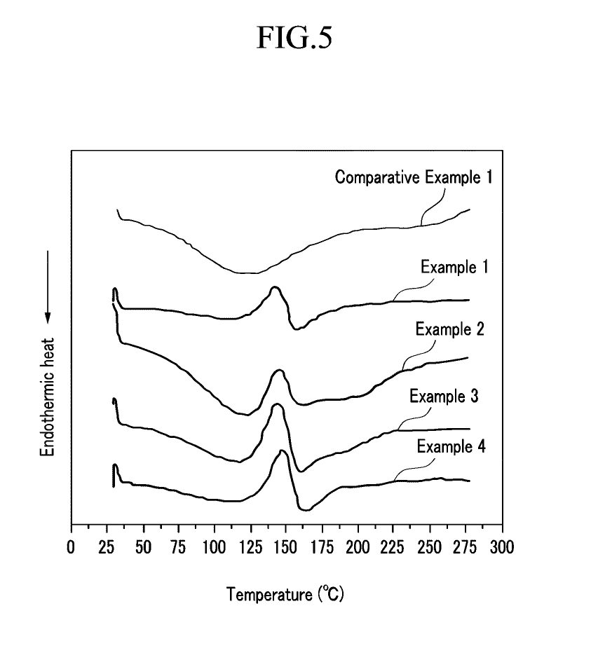

1) Differential scanning calorimeter (DSC, TA Instrument 2010 DSC) measurement: 0.3 g of a polymer electrolyte membrane for a fuel cell was positioned in a differential scanning calorimeter, and heated from room temperature to 300° C. at a speed of 10° C./min. The result is shown in FIG. 5. The crystalline fusion enthalpy is shown in the following Table 1.

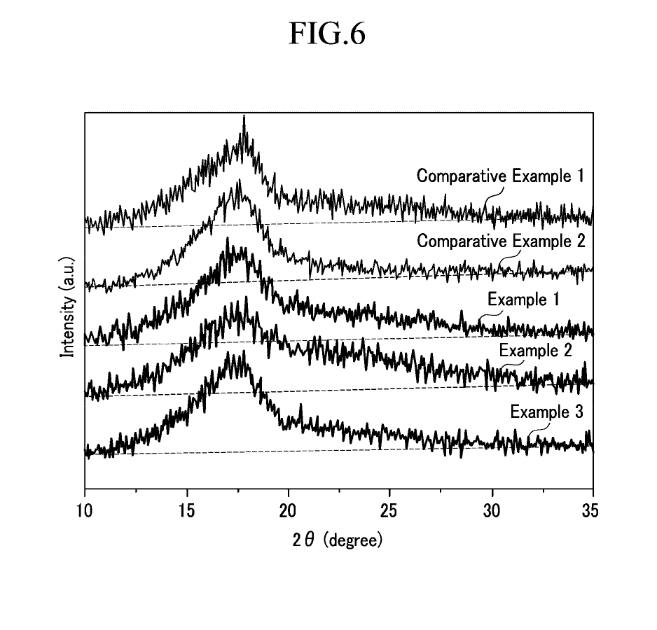

2) Wide-angle X-ray diffraction spectrum (40 Kv, 30 Ma, Model DMAX 2000; Rigaku Denki, Tokyo, Japan) measurement: it was measured at room temperature at a speed of 10° C./min in the range of 5 to 40° C. The result is shown in FIG. 6. The result of XRD peak intensity ratio (H^{22.5}/N^{17.5}) of XRD peak intensity (H^{22.5}) at a diffraction angle (2θ) of 22.5 degrees with respect to XRD peak intensity (N^{17.5}) at a diffraction angle (2θ) of 17.5 degrees is shown in the following Table 1.

TABLE 1

| | Proton conductive | Polyhydric | | Crystalline | |
|---|---|---|---|---|---|
| | polymer powder | alcohol | Solvent | fusion | |
| | (parts by | (parts by | (parts by | enthalpy | |
| | volume) | volume) | volume) | (J/g) | H^{22.5}/N^{17.5} |
| Example 1 | 100 | DPG (700) | DW (300) | 72.0 | 0.60 |
| Example 2 | 100 | DPG (700) | IPA (300) | 67.3 | 0.60 |
| Example 3 | 100 | DPG (300) | IPA (700) | 95.6 | 0.40 |
| Example 4 | 100 | DPG (1000) | (0) | 92.3 | 0.72 |
| Comparative | Commercially | (0) | (0) | No | 0.16 |
| Example 1 | available NAFION ® | | | crystalline | |
| | 211 (DuPont) | | | peaks | |
| Comparative | 100 | (0) | (0) | 42 | 0.20 |
| Example 2 | | | | | |

DPG: dipropylene glycol
DW: distilled water
IPA: isopropyl alcohol

As shown in FIGS. 5 and 6 and Table 1, the polymer electrolyte membranes for a fuel cell according to the embodiments including a polyhydric alcohol to minimize agglomeration of an ion group maximize dispersion of an ionomer and improve chain mobility, indicating that it derives additional crystallization by a simple heat treatment.

<Manufacturing Membrane-Electrode Assembly>

### Examples 5 to 8

A catalyst composition including a Pt—Ru catalyst supported on a carbon carrier, a perfluorosulfonate (NAFION®) binder, and an isopropyl alcohol solvent was coated on a polytetrafluoroethylene (PTFE) film. The catalyst compositions coated on the PTFE film were positioned on one side of the polymer electrolyte membranes prepared according to Examples 1 to 4, and they were heat-pressed together at 150° C. with a pressure of about 700 psi for 3 minutes to transfer catalyst compositions into the polymer electrolyte membranes, respectively. The mixing ratio of the catalyst and binder was 64:36 wt %. Membrane-electrode assemblies were fabricated by transferring catalyst compositions coated on the PTFE film into the other sides of the polymer electrolyte membranes according to Examples 1 to 4.

### Comparative Examples 3 and 4

Membrane-electrode assemblies were fabricated according to the same method as in Example 5, except that the polymer electrolyte membranes prepared according to Comparative Examples 1 and 2 were used.

### Experimental Example 2

### Performance of a Membrane-Electrode Assembly

Fuel cells were fabricated by positioning gas diffusion layers (SGL Carbon Group, 35BC) on both sides of the membrane-electrode assemblies prepared according to Examples 5 to 8 and Comparative Examples 3 and 4. The fuel cells were tested under conditions of using hydrogen and oxygen at about 60° C. at a fuel supplying stoichiometric ratio of 1.2/2.5 (anode/cathode).

From the results, fuel cells including the membrane-electrode assembly according to Examples 5 to 8 showed excellent power density, lower membrane resistance, and lower hydrogen cross-over than those including the membrane-electrode assembly according to Comparative Examples 3 and 4.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A polymer electrolyte membrane for a fuel cell, the polymer electrolyte membrane having a crystallinity such that a crystalline fusion enthalpy of the polymer electrolyte membrane measured by differential scanning calorimetry (DSC) is about 67.3 J/g or more.

2. The polymer electrolyte membrane of claim 1, wherein the crystalline fusion enthalpy of the polymer electrolyte membrane as measured by differential scanning calorimetry (DSC) is less than about 130 J/g.

3. The polymer electrolyte membrane of claim 1, wherein the polymer electrolyte membrane has an exothermic peak in the range of about 125 to about 200° C. as measured by differential scanning calorimetry (DSC).

4. The polymer electrolyte membrane of claim 1, wherein the polymer electrolyte membrane has an X-ray diffraction (XRD) peak at a diffraction angle (2θ) of about 2θ to about 23 degrees in a wide-angle X-ray diffraction spectrum analysis using a CuKα ray.

5. The polymer electrolyte membrane of claim 1, wherein the polymer electrolyte membrane has a peak intensity ratio (H/N) ranging from about 0.3 to about 0.9, and
wherein the peak intensity ratio (H/N) is a ratio of an XRD peak intensity (H) at a diffraction angle (2θ) of about 20 to about 23 degrees with respect to an XRD peak intensity (N) at a diffraction angle (2θ) of about 16 to about 18 degrees.

6. The polymer electrolyte membrane of claim 1, wherein the polymer electrolyte membrane is formed from a mixture of a proton conductive polymer powder and a polyhydric alcohol.

7. The polymer electrolyte membrane of claim 1, wherein the polymer electrolyte membrane is formed from a mixture of a proton conductive polymer powder; and
a polyhydric alcohol having a solubility parameter (δ) ranging from 8 to 24 (cal/cm³)^{1/2}.

8. The polymer electrolyte membrane of claim 6, wherein the polyhydric alcohol is one of a glycerol, an alkyleneglycol, an alkyleneglycol alkylether, or combinations thereof.

9. The polymer electrolyte membrane of claim 6, wherein the polyhydric alcohol has a solubility parameter (δ) ranging from 9.5 to 13 (cal/cm³)^{1/2}.

10. The polymer electrolyte membrane of claim 1, further comprising an ionomer cluster agglomeration having a particle diameter of about 280 nm.

11. The polymer electrolyte membrane of claim 1, further comprising an ionomer cluster agglomeration having an average particle diameter of about 5 to about 300 nm.

12. A method of manufacturing a polymer electrolyte membrane for a fuel cell, comprising:
preparing a cluster by mixing a proton conductive polymer powder and a polyhydric alcohol;
drying the cluster; and
heat-treating the dried cluster.

13. The method of claim 12, wherein the cluster comprises about 10 to about 1000 parts by volume of a polyhydric alcohol based on 100 parts by volume of the proton conductive polymer powder.

14. The method of claim 12, wherein the proton conductive polymer powder comprises a cation exchange group selected from the group consisting of a sulfonic acid group, a carboxylic acid group, a phosphoric acid group, a phosphonic acid group, and derivatives thereof, at its side chain.

15. The method of claim 12, wherein the polyhydric alcohol has a solubility parameter (δ) ranging from about 8 to about 24 (cal/cm³)^{1/2}.

16. The method of claim 12, wherein the drying process is performed at a temperature of about 60 to about 80° C.

17. The method of claim 12, wherein the heat treatment is performed at a temperature of about 100 to about 140° C.

18. A membrane-electrode assembly for a fuel cell, comprising:
an anode and a cathode facing each other; and
a polymer electrolyte membrane disposed between the anode and cathode,
wherein the polymer electrolyte membrane has a crystallinity such that a crystalline fusion enthalpy measured by differential scanning calorimetry (DSC) is about 67.3 J/g or more.

19. The membrane-electrode assembly for a fuel cell of claim 18, wherein the polymer electrolyte membrane has an exothermic peak in the range of about 125 to about 200° C. as measured by differential scanning calorimetry (DSC).

20. The membrane-electrode assembly for a fuel cell of claim 18, wherein the polymer electrolyte membrane has an X-ray diffraction (XRD) peak at a diffraction angle (2θ) of about 20 to about 23 degrees in a wide-angle X-ray diffraction spectrum analysis using a CuKα ray.

21. The membrane-electrode assembly for a fuel cell of claim 18, wherein the polymer electrolyte membrane has a peak intensity ratio (H/N) ranging from about 0.3 to about 0.9, and
wherein the intensity ratio (H/N) refers to a ratio of an XRD peak intensity (H) at a diffraction angle (2θ) of about 20 to about 23 degrees with respect to an XRD peak intensity (N) at a diffraction angle (2θ) of about 16 to about 18 degrees.

22. The membrane-electrode assembly for a fuel cell of claim 18, wherein the polymer electrolyte membrane is formed from a mixture of a proton conductive polymer powder and a polyhydric alcohol.

23. The membrane-electrode assembly for a fuel cell of claim 18, wherein the polymer electrolyte membrane is formed from a mixture including a proton conductive polymer powder having a cation exchange group selected from the group consisting of a sulfonic acid group, a carboxylic acid group, a phosphoric acid group, a phosphonic acid group, and derivatives thereof, at its side chain, and
a polyhydric alcohol having a solubility parameter (δ) ranging from 8 to 24 (cal/cm³)^{1/2}.

24. A fuel cell system comprising:
an electricity generating element comprising an anode and a cathode facing each other and a polymer electrolyte membrane disposed therebetween;
a fuel supplier; and
an oxidant supplier,
wherein the polymer electrolyte membrane comprises the polymer electrolyte membrane of claim 1.
